(19) United States
(12) Patent Application Publication
(10) Pub. No.: US 2002/0070954 A1
(43) Pub. Date: Jun. 13, 2002

(54) Fitness enabling and motivating service

(76) Inventor: Ken Lang, Wellesley, MA (US)

Correspondence Address: LAHIVE & COCKFIELD, 28 STATE STREET, BOSTON, MA, 02109, US

(21) Appl. No.: 10/010,393

(22) Filed: Dec. 7, 2001

Related U.S. Application Data
(60) Provisional application No. 60/254,038, filed on Dec. 7, 2000.

(51) Int. Cl. G06F 7/00

(52) U.S. Cl. 345/700

(57) ABSTRACT

A fitness enabling and motivating service provides an online resource for assisting users in staying physically fit. The service enables users to locate well-matched partners for fitness activities. The service may facilitate communications between participants in fitness activities. The service may also enable each user to maintain an online schedule of fitness activities. Fitness activities may be scheduled and arranged via the server.

### RELATED APPLICATION

The current application claims priority from Provisional Patent Application S/N 60/254,038, entitled FITNESS ENABLING AND MOTIVATING SERVICE, which was filed on Dec. 7, 2000, all naming the same inventors and the same assignee as this application, which is incorporated by reference herein.

### TECHNICAL FIELD

The present invention relates generally to physical fitness activities and more particularly to a fitness enabling and motivating service.

### BACKGROUND OF THE INVENTION

There are many challenges that prevent people from being physically fit. One of the challenges is that many people enjoy only a small subset of fitness activities. However, some of these fitness activities require partners and often times it is difficult to find a partner at the same skill level in the same vicinity with a matching schedule. Another barrier to achieving physical fitness is the inability of parties to stay motivated. One way to increase motivation is to have a partner that participates in the same fitness activity and encourages the party to continue to participate in the fitness activity.

### SUMMARY OF THE INVENTION

The present invention addresses the above-described problems that prevent people from being physically fit. The present invention provides a fitness enabling and motivating service. In one embodiment of the present invention, the service is accessible via an online site, such as a web site. The service enables participants to find well-matched partners (i.e., “fitpals”) for participating in fitness activities. The partners may be matched by skill level, locale, age, gender, schedule and other criteria. A participant may specify the matching criteria and then submit a search to identify well-matched potential fitness partners.

The service may also enable a participant to send invitations, such as by electronic mail or by instant messaging, to other parties to schedule a fitness activity. For example, a participant may wish to schedule a doubles tennis match and send an invitation to three other parties via electronic mail. The parties may have the opportunity to accept or decline the invitation. Once at least one of the invitees has accepted the invitation, the activity is added to the schedules for the participants that are maintained online. Each schedule specifies a time, date, place, and other information regarding fitness activities involving the associated party. The schedules serve as useful reminders for participants of when fitness activities are scheduled.

Participants are able to provide feedback regarding fitness activities and fellow participants. This information may be available online for other parties to use while scheduling fitness activities. There is flexibility built in the service to allow cancellation of fitness activities, cancellation of participation in fitness activities by parties, changing the particulars of a scheduled fitness activity and the like.

The service may automatically generate reminders of fitness activities for participants. These reminders may take many forms, including the form of electronic mail or instant messaging messages. A participant may specify whether they wish to have such reminders or not. In addition, participants for a scheduled fitness activity may send messages to each other via the service.

In accordance with one aspect of the present invention, a method is practiced in an electronic device so that user profiles regarding users and fitness activities of the users are provided. These profiles are examined to match at least two selected ones of the users for a scheduled fitness activity.

In accordance with another aspect of the present invention, a web site is provided that has a matching facility for identifying persons that are well-matched to a first user for a particular type of fitness activity. The web site also has a scheduling facility for scheduling fitness activities among persons. The matching facility is used to identify at least one person as well-matched to the first user for the first type of fitness activity. The scheduling facility is used to schedule a first event of the first type of fitness activity between participants, including the first user and the well-matched person.

### BRIEF DESCRIPTION OF THE DRAWINGS

An illustrative embodiment of the present invention will be described below relative to the following drawings.

FIG. 1 is a block diagram of an environment suitable for practicing the illustrative embodiment of the present invention.

FIG. 2 is a flow chart illustrating the steps that are performed for a user to register with the service of the illustrative embodiment.

FIG. 3A illustrates a display screen that is provided to facilitate a user registering with the service.

FIG. 3B illustrates a portion of a screen display that prompts the user to provide information regarding activities that are of interest to the participant.

FIG. 3C illustrates a portion of a screen display that enables a participant to specify locations for fitness activities.

FIG. 4 is a flow chart illustrating the steps that are performed when a participant requests the service to search for fitpals.

FIG. 5A illustrates a user interface component that is displayed for a participant to identify desired characteristics for fitpals.

FIG. 5B illustrates the user interface component that displays example search results responsive to a request to identify suitable fitpals.

FIG. 5C illustrates a portion of a display screen where a participant may request a constant fitpal search.

FIG. 5D illustrates a portion of a screen display that allows a user to enable partner search profiles.

FIG. 6 is a flow chart illustrating the steps that are performed by the service to locate a fitpal.

FIG. 7 illustrates a portion of a screen display that enables a participant to edit a fitpal list.

FIG. 8 shows an example of a suitable web page provided by the service of the illustrative embodiment.

FIG. 9 is a flow chart illustrating steps that are performed to initiate the scheduling of a fitness activity.

FIG. 10A illustrates a screen display 310 that is displayed to plan a fitness activity.

FIG. 10B illustrates an example of an invitation communication.

FIG. 11A illustrates an example of a screen display that summarizes an activity that is already scheduled.

FIG. 11B illustrates an example of communication that is sent to inform participants that an activity has been cancelled.

FIG. 12 shows an example of a communication that is sent to indicate that the perimeters associated with the fitness activity have changed.

FIG. 13 is an example of a communication indicating that an invitee to a fitness activity has cancelled.

FIG. 14 shows an example of a reminder communication.

FIG. 15 illustrates an example of a screen display where a participant is prompted to provide feedback regarding a fitness activity.

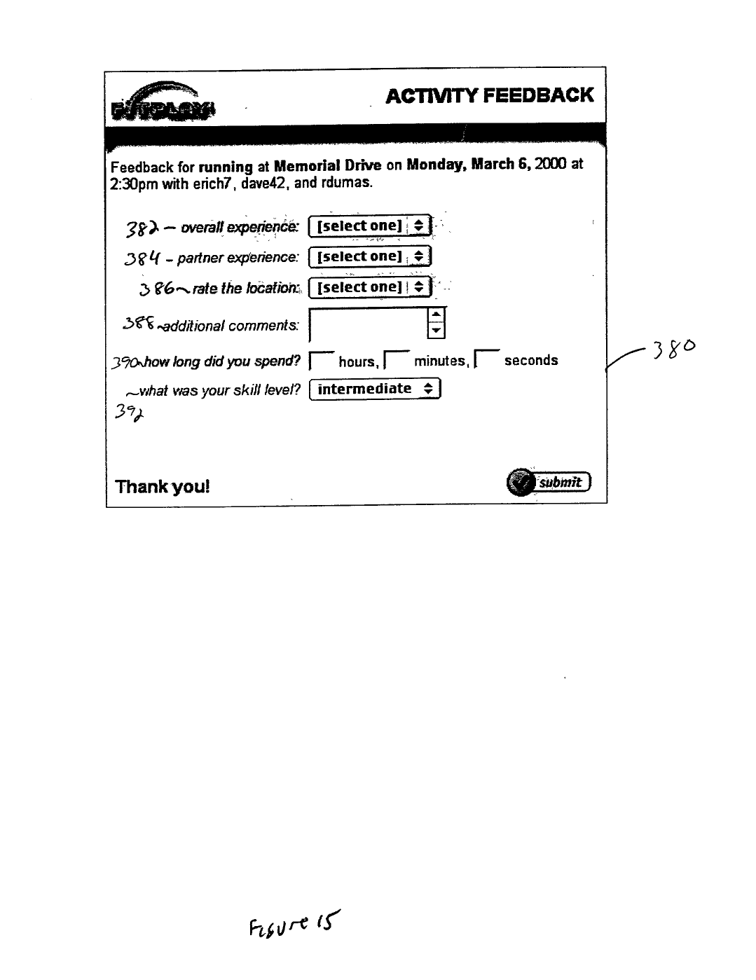

FIG. 16A shows an example of a day's view of a calendar.

FIG. 16B illustrates an example of a week's view of a calendar.

FIG. 16C illustrates a month's view of a calendar.

### DETAILED DESCRIPTION OF THE INVENTION

The illustrative embodiment of the present invention provides an online service for enabling fitness activities among multiple participants. The service also helps motivate individuals to participate in fitness activities by making it easier to find well-matched fellow participants. The service may provide enabling technologies for reminding a party of the scheduled fitness activities, reviewing a party's scheduled fitness activities and the like. The service provides a convenient infrastructure for participants in fitness activities to communicate with each other. Resources, such as electronic mail and instant messaging, may be provided to facilitate such communications.

The illustrative embodiment may be implemented using a web site that is available via the Internet or another variety of computer network. Users may access the web site using a number of different technologies. For example, users may access the web site via computer, cellular phone, intelligent pager, Internet appliance, or via other suitable mechanism. It should be appreciated that online mechanisms other than a web site, may be used to practice the present invention.

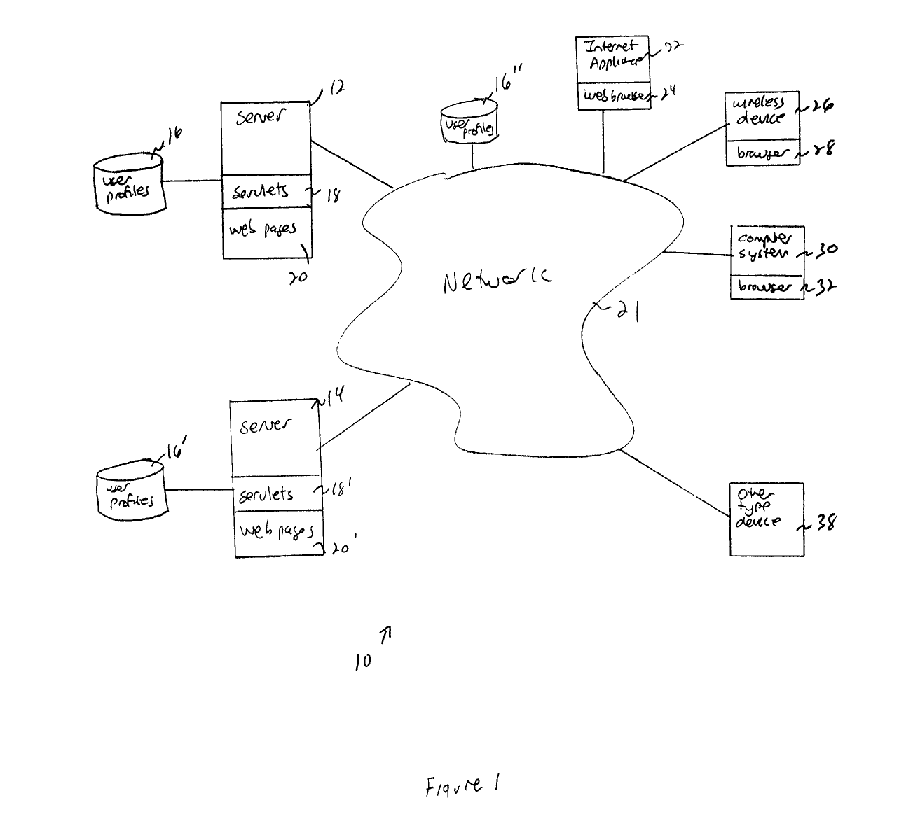

FIG. 1 illustrates an environment 10 that is suitable for practicing the illustrative embodiment of the present invention. The environment 10 includes a server 12. The server 12 includes servlets 18 or other code modules that support the service of the illustrative embodiment. A number of web pages 20 may be provided for the web site. The server 12 has access to a database 16 of user profiles. Each user profile holds information regarding a user, including information regarding fitness activities, as will be described in more detail below.

It should be appreciated that the service of the illustrative embodiment need not be implemented by a single server; rather as shown in FIG. 1, an additional server 14 may be provided. In fact, a large number of servers may be provided to facilitate load balancing, availability and, in general, to reduce latency of transactions with users. The server 14 also holds copies of the servlets 18′ and the web pages 20′. The server 14 holds a copy of the user profiles 16′.

Those skilled in the art will appreciate that the servers 12 and 14 need not hold identical servlets and web pages. In some instances, particular users in given geographic locales or alternatively, users interested in a subset of fitness activities are assigned one of the servers. The servlets and web pages facilitate interaction with the service from the respective geographic locales or for the respective subset of users interested in only a subset of the fitness activities. In such instances, the user profiles 16 and 16′ may be divided and stored separately rather than being copies of each other. Those skilled in the art will also appreciate that the user profiles 16″ may be located remotely and accessible via a network 21. The network 21 may be a computer network, such as the Internet, an intranet, an extranet, or a communication network, such as a wireless network.

As was mentioned above, users may access the web site provided by the service using a number of different types of user devices. For example, as shown in FIG. 1, an Internet appliance 22 that runs a copy of a web browser 24 may be used. The Internet appliance 22 communicates over the network 21 with the server 12 to access the web site. Similarly, a wireless device 26, such as a pager, a mobile phone, or a personal digital assistant (PDA), may be used to communicate with the server 12. The wireless device 26 may have a browser 28, such as a mini-browser, as found in some wireless devices. A computer system 30 may provide a web browser 32 to facilitate access to the server 12. Other types of devices 38 may-also be utilized.

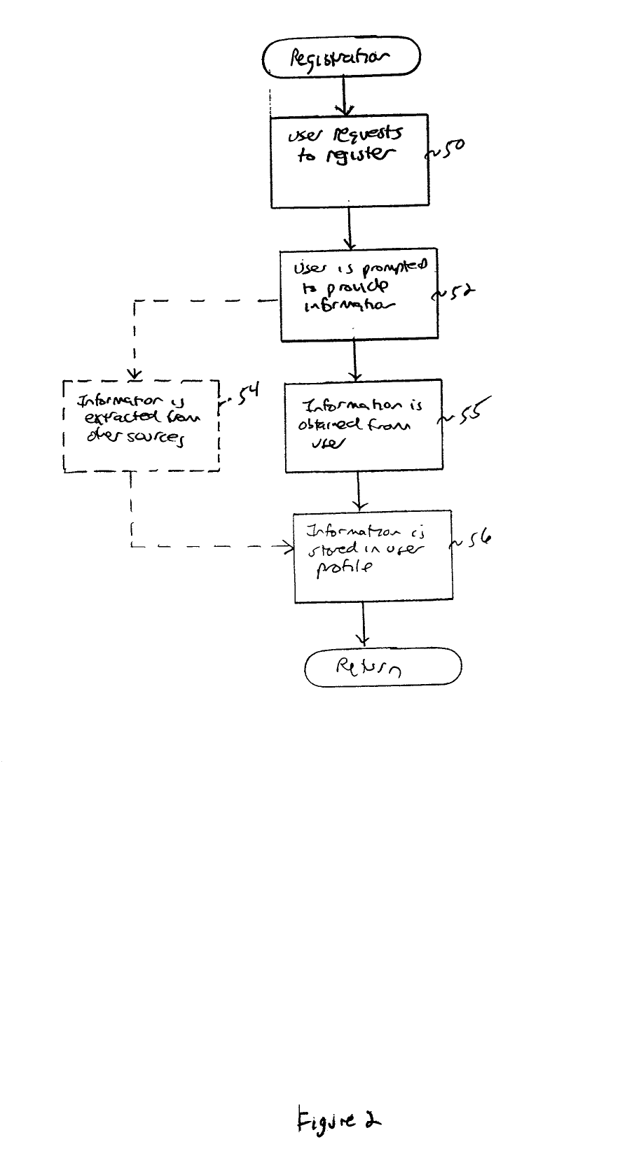

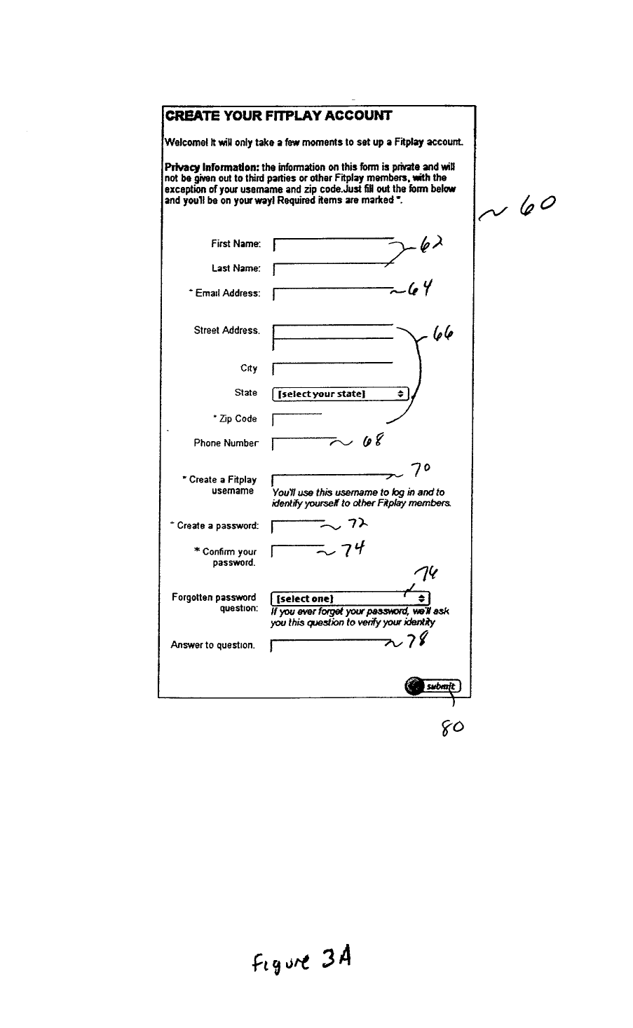

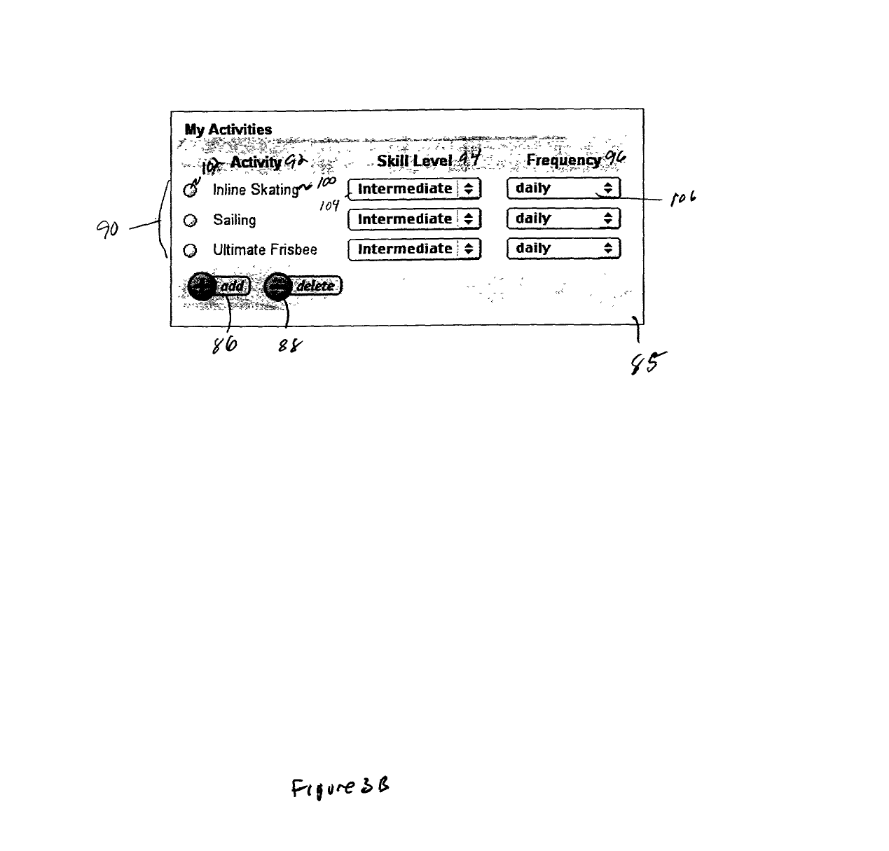

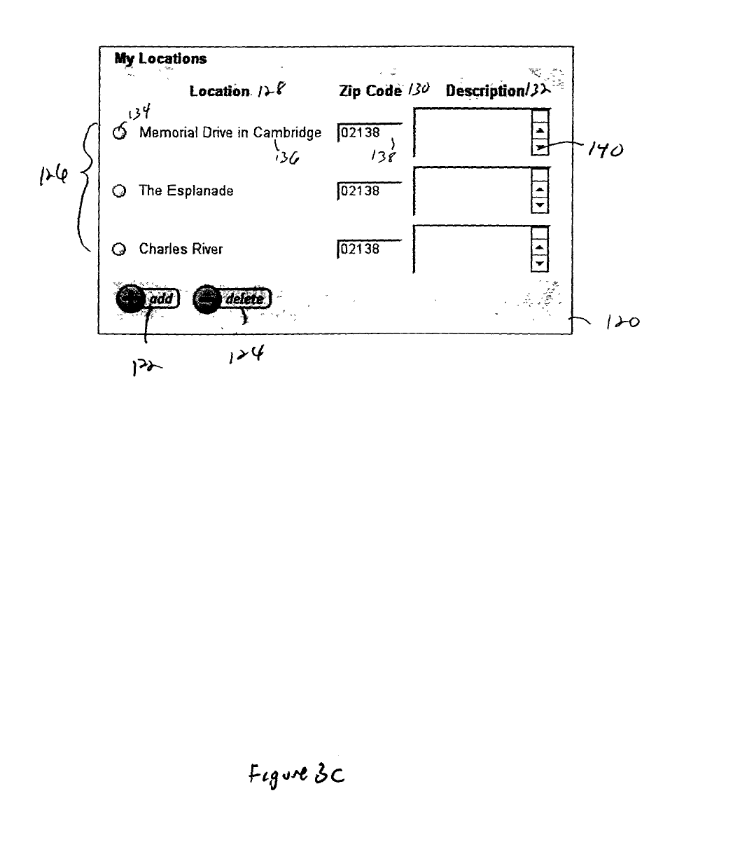

In order for a user to become a participant in the service, the user must register with the service. This is typically performed by the user visiting the web site and following the steps outlined by web pages at the web site to register. FIG. 2 illustrates a flow chart of the steps that are performed during registration. Initially, the user requests to register with the service (step 15 in FIG. 2). The user may, for example, click on the appropriate portion of a web page provided at the web site for the service. The user is then prompted to provide the appropriate information to complete the registration (step 52 in FIG. 2). FIG. 3A shows an example of a form 60 that may be provided at the web site for a user to register for the service. The form may ask the user for his name 62 as well as his email address 64. The user may be prompted to provide address information 66 and a phone number 68. The user need not use his actual name for the service. Hence, a text box 70 is provided on the form 60 to enable to the user to create a user name that is particular to the service. The user is prompted to provide a password 72 and is requested to enter the password again in text box 74 to confirm the password. The user may be requested to select a question from a drop down list 76. This question will be asked if the user forgets his password and wishes to still gain access to the service. The user must provide the answer to the question, such as “what is your mother's maiden name?” in text box 78. After the form 60 is completed, the user may activate the submit button 80 to submit the provided information.

FIG. 3B shows an example of additional activity that may be requested to complete registration. The user must identify which fitness activities are of interest to the user. When the activity box 85 is displayed initially, no activities are listed. The activity box 85 includes an “add” button 86 that may be activated to add activities. The user is prompted to identify the activities that are of the interest of the user, assessment by the user of his skill level in the identified fitness activities and the frequency with which the user participates in the fitness activities. FIG. 3B shows an example where the list 90 of activities of interest to the user includes an “activity column” 92, a “skill level” column 94 and a “frequency” column 96. The “activity” column 92 lists an in-line skating entry 100 that may be selected by activating button 102. A drop down list box 104 specifies the skill level of the user for in-line skating as the “intermediate” level, and a list box 106 specifies the frequency for which the user participates in in-line skating as “daily.” This list grows or shrinks as the user adds or removes activities. A “delete” button 88 is provided to remove fitness activity from the list.

The user may also be prompted to provide location information (i.e., desired location of fitness activities) for fitness activities. To that end, a location box 120 may be displayed. The “location” box 120 includes a list 126 of locations for physical fitness activities. For each location, an identification of a location 128 is provided along with the zip code 130 and an optional textual description 132. For example, an entry is provided for “Memorial Drive in Cambridge.” A selection button 134 is provided along with the name 136 of the location. The zip code 138 for the location and a description box 140 is provided. Users may add locations by activating the add button 122 or delete locations by activating the delete button 124.

Once the information has been obtained (step 55 in FIG. 2), the information is stored in the user's profile (step 56 in FIG. 2). Those skilled in the art will appreciate that user profile information may also be provided from alternative sources, such as from other computer records and the like. In such a case the information is extracted from the other sources (step 54 in FIG. 2) and stored in the user profile (step 56 in FIG. 2).

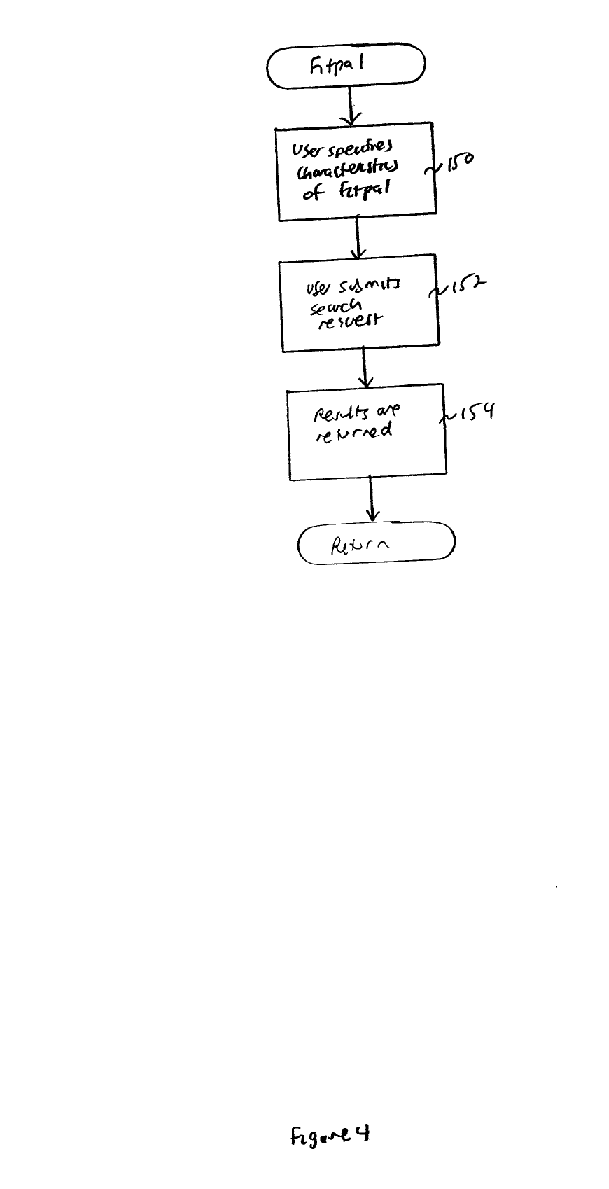

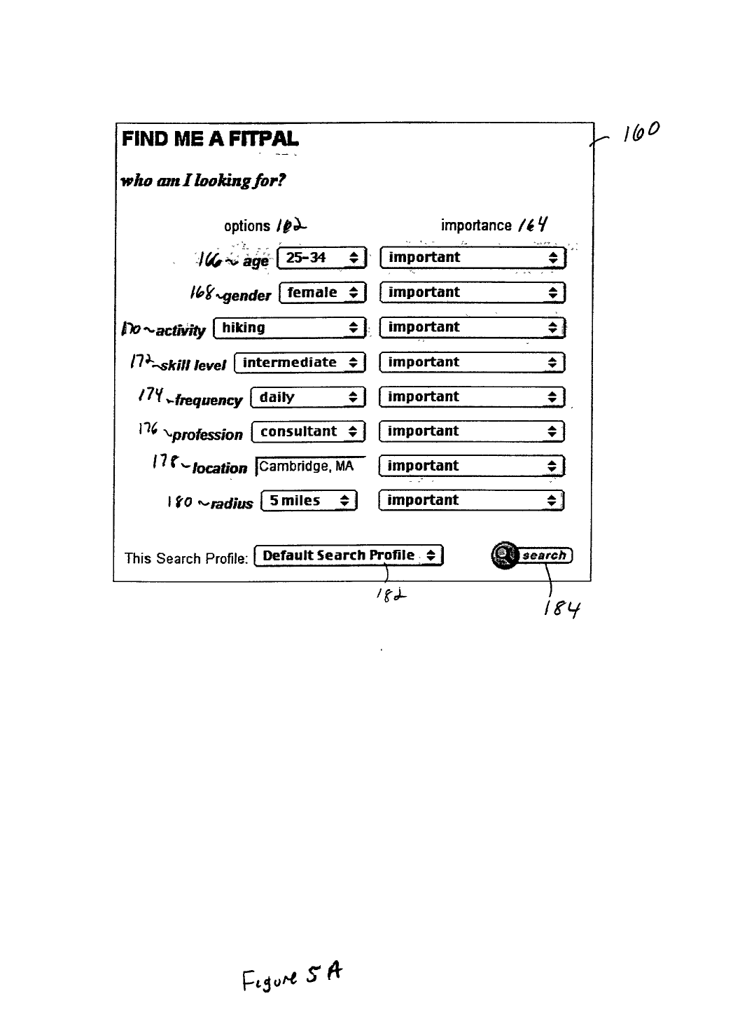

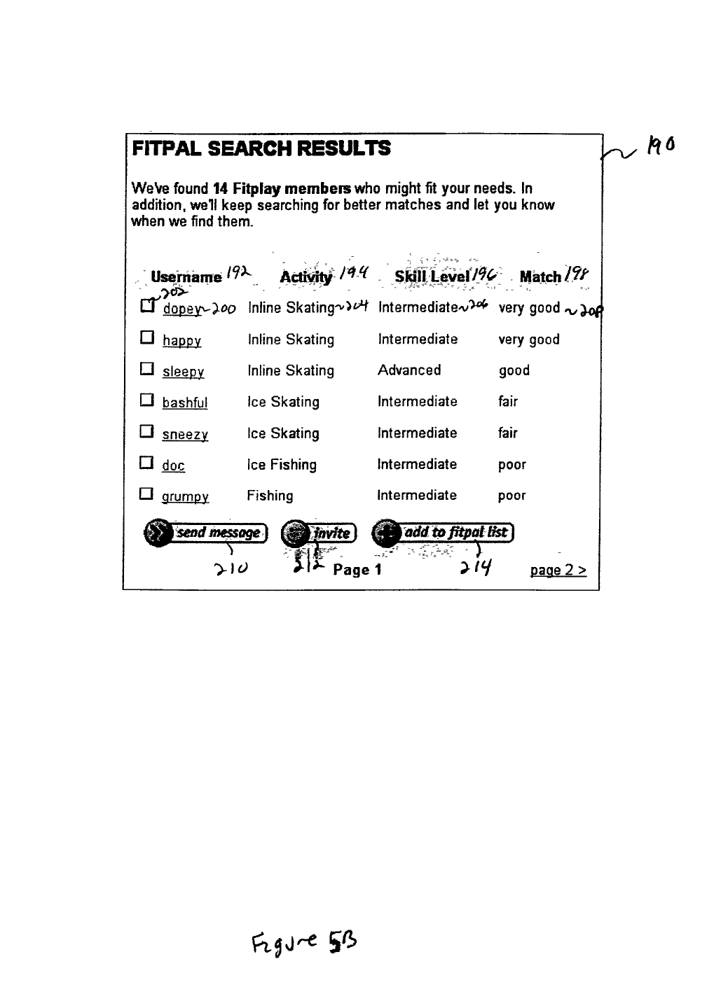

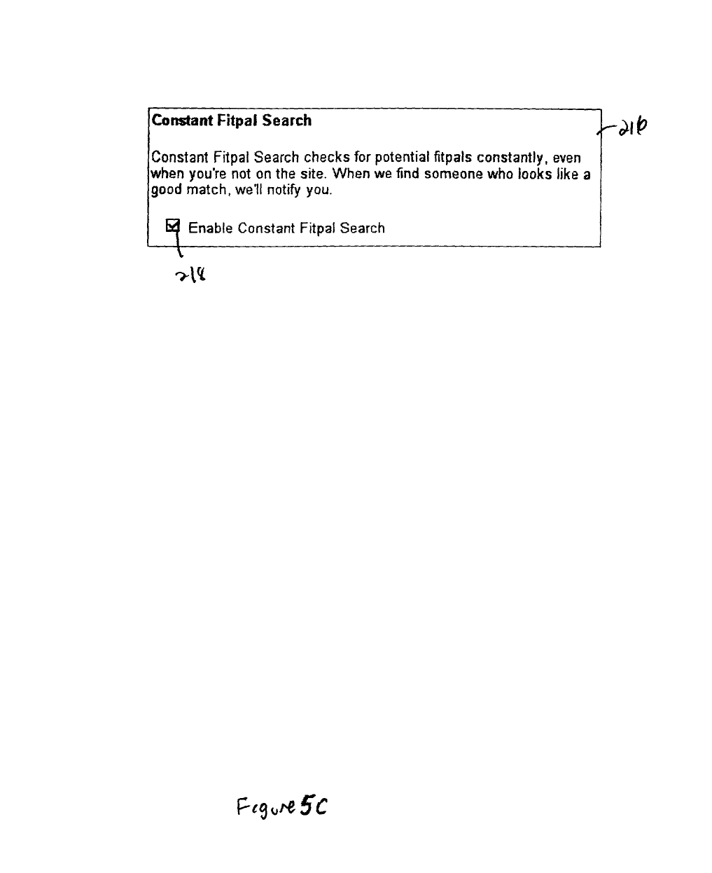

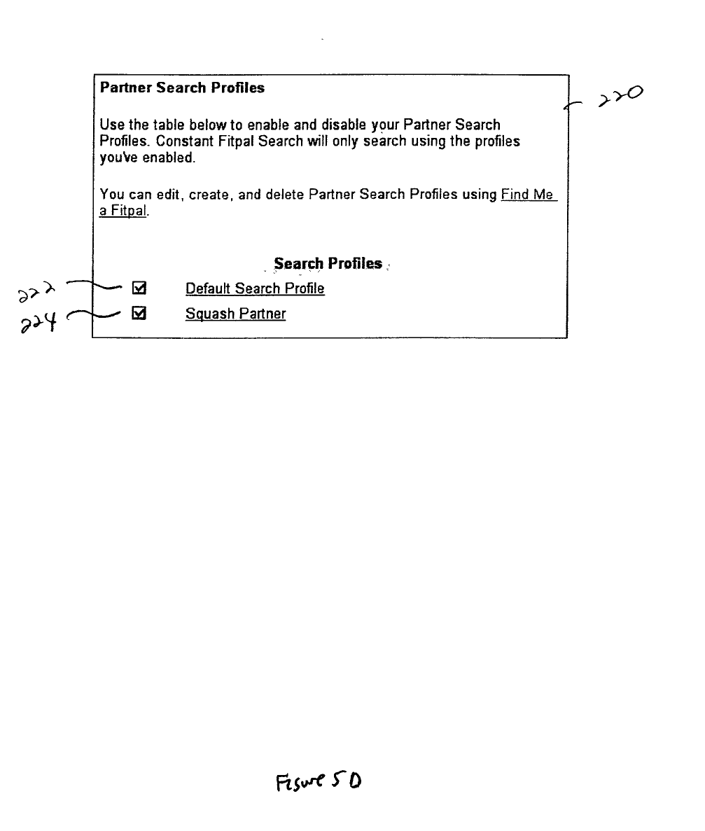

The service provided by the illustrative embodiment allows participants in the service to search for suitable parties that are well-matched to participate in fitness activities with the participant. These well-matched parties that are accepted by the user become “fitpals” for the user. FIG. 4 is a flow chart illustrating the steps that a user performs to locate fitpals. Initially, the user specifies desired characteristics of fitpals (step 150 in FIG. 4). FIG. 5A shows an example of a form 160 that may be completed to identify characteristics that are desired of fitpals for user. It should be appreciated the user need not complete each of the fields listed on the form 160; rather the user may specify only a subset of the characteristics that are of interest to the user. For each characteristic, the user is prompted to select an option 162 and the importance 164 of the option. The form 160 asks the user to specify an age range preference 166 and a gender preference 168. The user may also specify fitness activities 170 of interest and the desired skill levels of fitpals 172 for such activities. The user may specify the frequency 174 with which desired fitpals participate in fitness activities. The form 160 enables the user to specify a desired profession 176 for fitpals and to specify a desired location 178 for fitpals. A radius 180 relative to the location where the fitpal is willing to participate in fitness activities may also be specified. In the list box 182, the user may specify the search profile associated with the form 160 as the default search profile that is used if no others are specified. Each search profile holds a set of desired characteristics for fitpals. For example, a user might have a first search profile that specifies women age 25-34 who are interested in hiking and a second search profile for mane aged 35-44 who are interested in basketball. A user may develop multiple search profiles by selecting different values for the fields contained in the form 160. When the user is ready to search for a fitpal, the user may activate the search button 184.

Those skilled in the art will appreciate that the user interface for specifying fitpal characteristics may differ from that shown in FIG. 5A. Moreover, in some alternative embodiments, the user may submit a query that specifies the desired characteristics (such as through a relational algebra) rather than via a form.

After user has specified the desired characteristics of a fitpal the user submits the search request (step 152 in FIG. 4). The results of the search are then returned (step 154 in FIG. 4). FIG. 5B shows an example of search results 190. A number of matching members of the service are listed. For each member, a user name 192, and activity 194, skill level 196, and indication of the skill level of the match 198 are provided. For example, the first user shown in the search results in FIG. 5B is named 200 “Dopey” and participates in “in-line skating” (see 204). Dopey has an “intermediate” skill level (see 206) in in-line skating and is a very good match (see 208) with the user that requested the search. A check box 202 is provided to enable the user to select one of the parties listed in the search results. The user then has the option of activating button 210 to initiate the sending of a message to the selected party or the option of activating button 212 to invite the selected party to a fitness activity. Still further, the user may activate button 214 to add the selected party to the list of fitpals that is maintained for the user.

Instead of searching for fitpals on a one time basis, a user may request that the system constantly check for well-matched fitpals (such as by way of a background process). The service provides a user interface element 216 like that depicted in FIG. 5C. The user interface element 216 contains a check box 218 that enables a constant fitpal search.

A user may also select which search profiles are employed in order to locate fitpals. The user interface 220 shown in FIG. 5D is suitable for the user to enable or disable search profiles. In the example shown in FIG. 5D, the default search profile may be enabled by check box 222, whereas the squash partner profile may be enabled by check box 224.

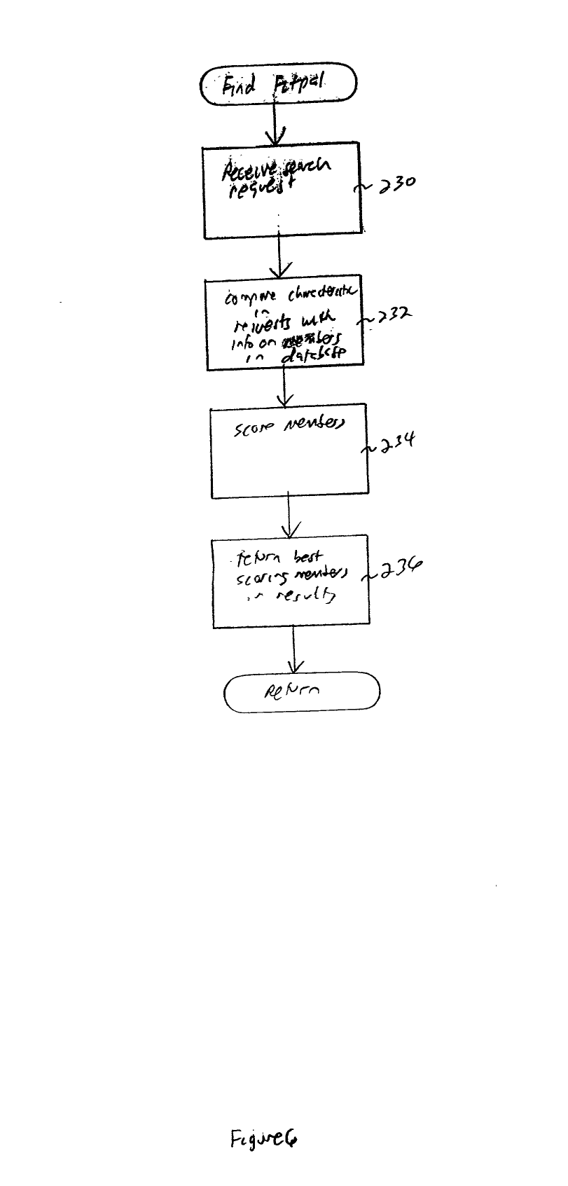

FIG. 6 shows a flow chart that illustrates the steps that are performed by the service in determining which fitpals to return in the search results. Initially, a search request is received along with an indication of which search profiles to use (step 230 in FIG. 6). The characteristics specified in the search request are then compared with the information maintained in the user profiles of members in the database 16 (step 232 in FIG. 6). A scoring algorithm may be employed to score the degree of match between a requesting user and members (step 234 in FIG. 6). Those skilled in the art will know of many different scoring algorithms that may be used. One approach is to score based on the number of criteria that are fulfilled or matched by the scored parties. A list of the best scoring members may then be returned in the search results (step 236 in FIG. 6).

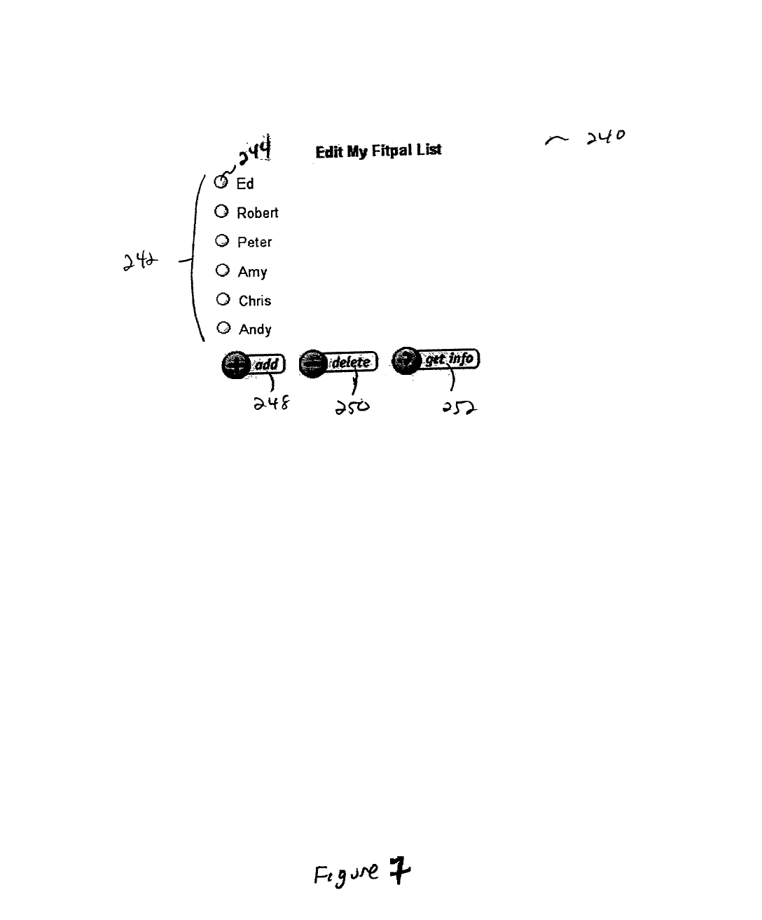

Once a fitpal list is generated, the fitpal list may be edited. FIG. 7 shows an example of a user interface 240 that allows the editing of a fitpal list. The user interface element 240 specifies a list 242 of users. A particular user may be selected by activating a button, such as button 244 for user “Ed.” The selected fitpal may be deleted by activating the delete button 250. In addition, additional information regarding the active fitpal may be obtained by activating the “get info” button 252. Additional parties may be added to the fitpal list by activating “add” button 248.

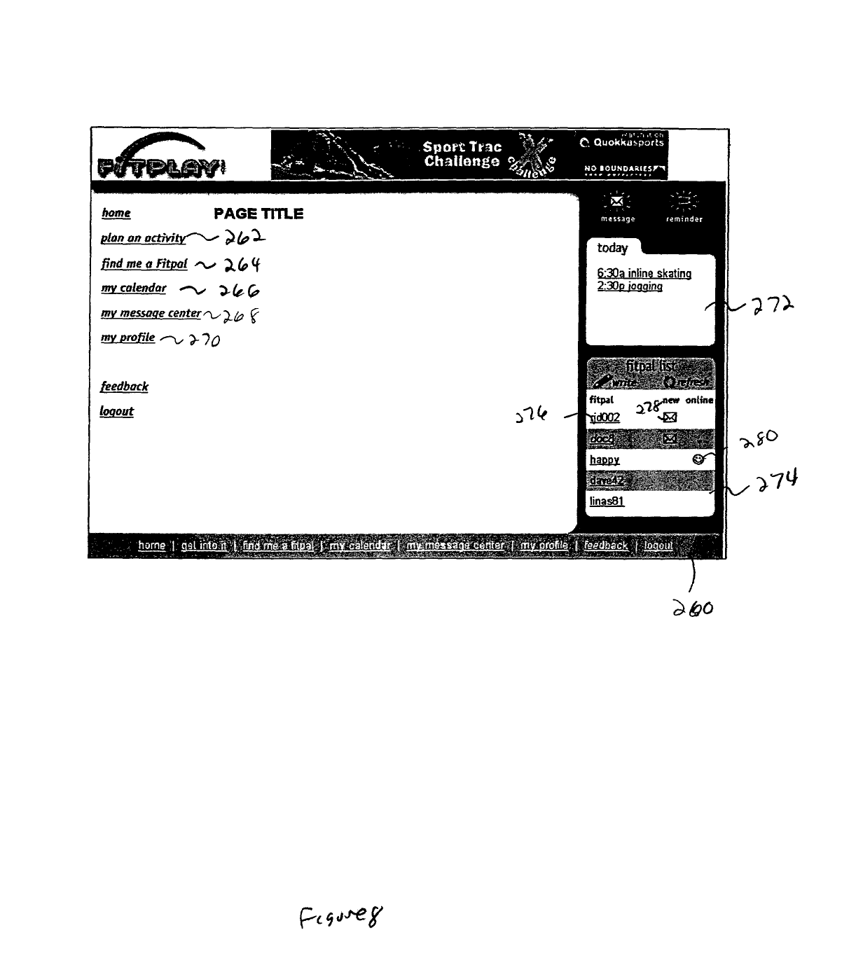

FIG. 8 depicts an example of a portion of a web page 260 that may be provided by the service to enable members to perform activities relative to the service. A member may plan a fitness activity by clicking on “plan an activity” 262. A member may find a fitpal by clicking on “find me a fitpal” 264 and review a calendar of fitness activities that is maintained by the service for the user by clicking on “my calendar” 266. The user may review messages sent to the user or initiate the sending of other messages by selecting “my message center” 268. A user may edit a user profile or review a user profile by selecting “my profile” 270. Information 272 regarding events of a current scheduled user may be displayed. A fitpal list may also be displayed for each fitpal, indication may be provided whether there is a new message from the fitpal. In the example shown in FIG. 8, a fitpal 276 has sent a message to the member as indicated by the envelope icon 278. Similarly, the icon 280 indicates that a fitpal is online, and the absence of the icon 280 indicates that the associated fitpal is not online.

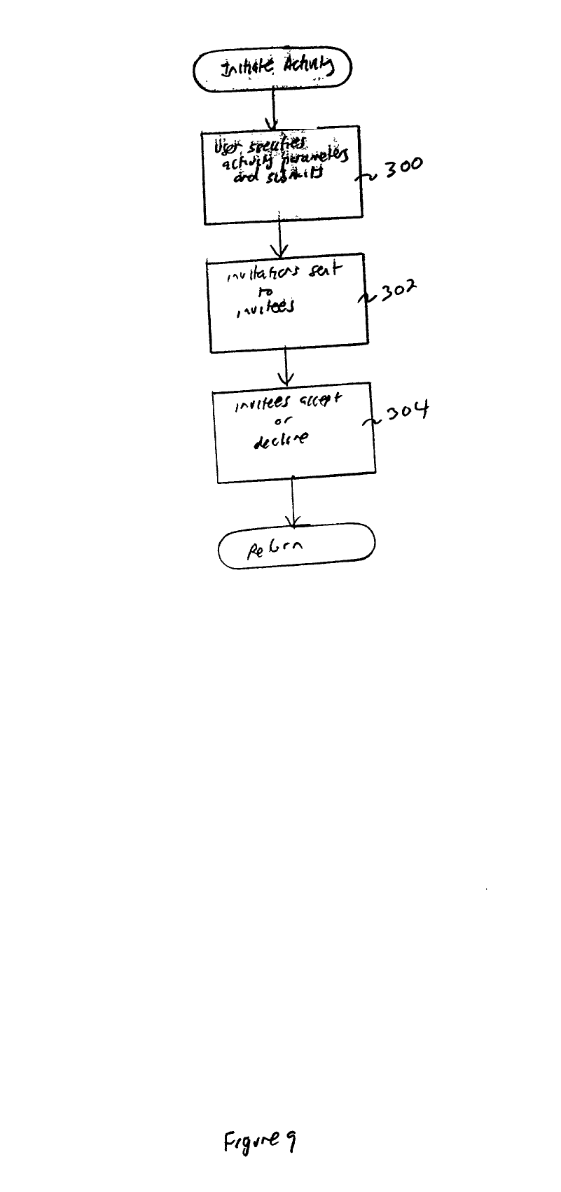

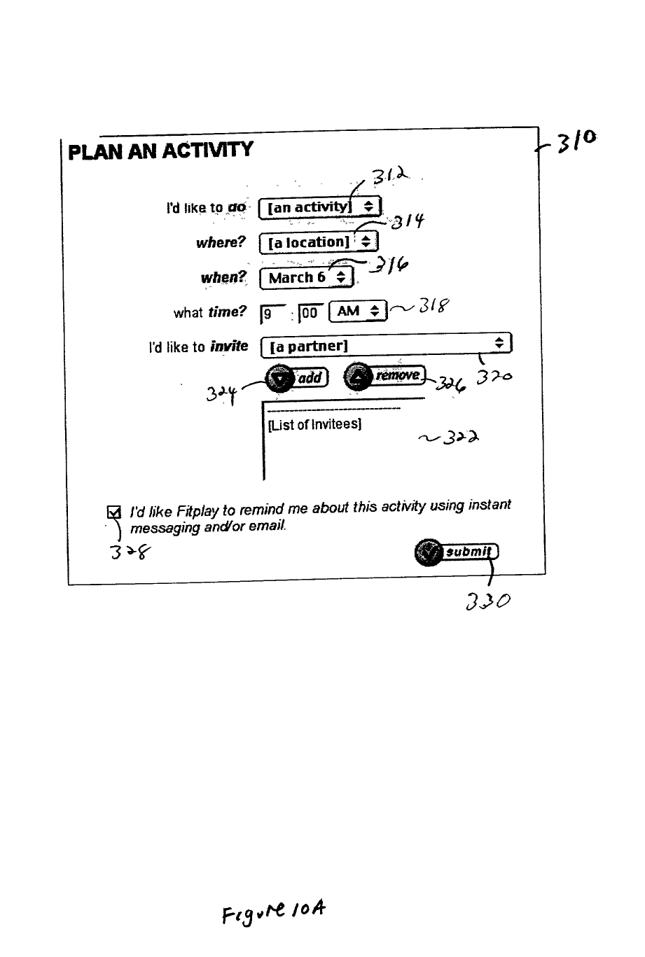

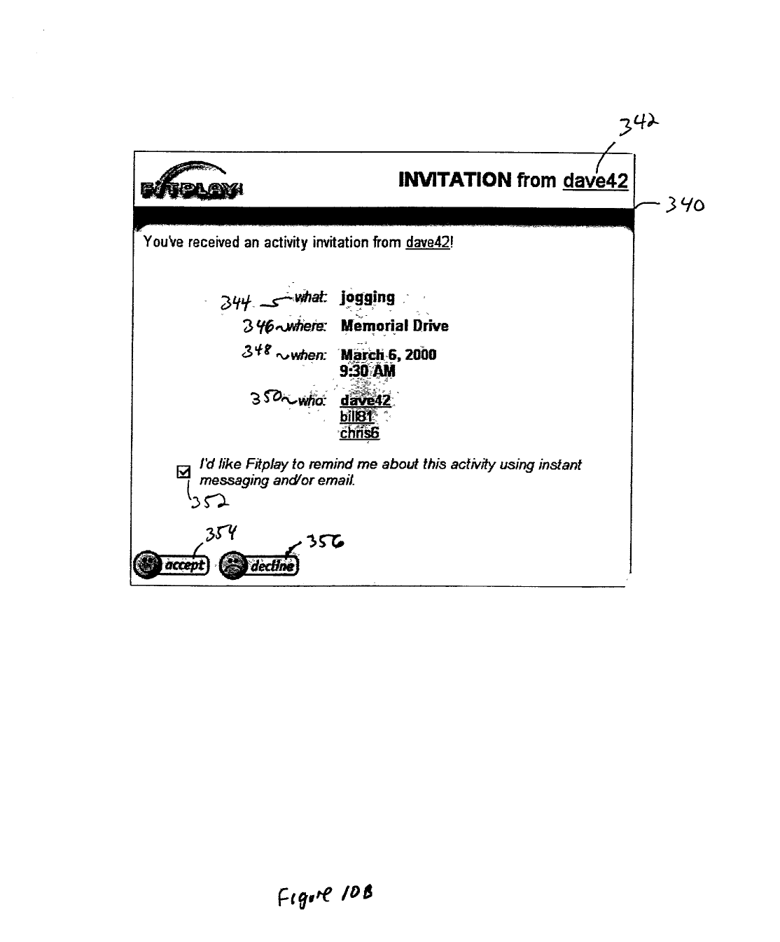

As mentioned above, a user may initiate the planning of a fitness activity, such as by clicking on the text 262. The user specifies activity parameters and then submits requests for scheduling of the activity (step 300 in FIG. 9). Other forms may be utilized, and, in some embodiments, the user may be asked a series of questions to obtain the requisite information. FIG. 10 shows an example of a form 310 that is provided by the service to plan an activity. A list box 312 is provided to the user to specify the type of activity that the user wishes to plan. List box 314 enables the user to select the location for the activity, and list box 316 enables the user to select a date for the activity. User interface elements 318 enable the user to select a time for the activity. List box 320 enables the user to identity what parties are to be invited. The parties are listed in area 322 and “add” button 324 may be provided to add a party as an invitee. Similarly, and invitee may be removed from the list by activating the “remove” button 326. The user may activate check box 328 so that the user is sent a reminder communication regarding the activity. Once the user has completed the form 310, the user may activate the “submit” button 330 to initiate the scheduling of an activity.

Once the user has submitted a request to schedule a fitness activity (step 300 in FIG. 9), an invitation is sent to the invitees (step 302 in FIG. 9). The invitations may take the form of electronic communications that are forwarded to the invitees. Suitable forms of communication include, but are not limited to, electronic mail messages and instant messages. FIG. 10B shows an example of an electronic mail invitation 340. The invitation 340 identifies the inviting party 342. The invitation also specifies the type of activity 344, the location of the activity 346, the date and time 348 of the activity and the invitees for to the activity 350. The invitee may accept the invitation by activating the “accept” button 354 or decline the invitation by activating the “decline” button 356. Check box 352 may be selected to request that reminders to be sent to the invitee. Thus, in step 305 in FIG. 4, the invitee accepts or declines the invitation. If there is a sufficient number of invitees, the activity may remain scheduled.

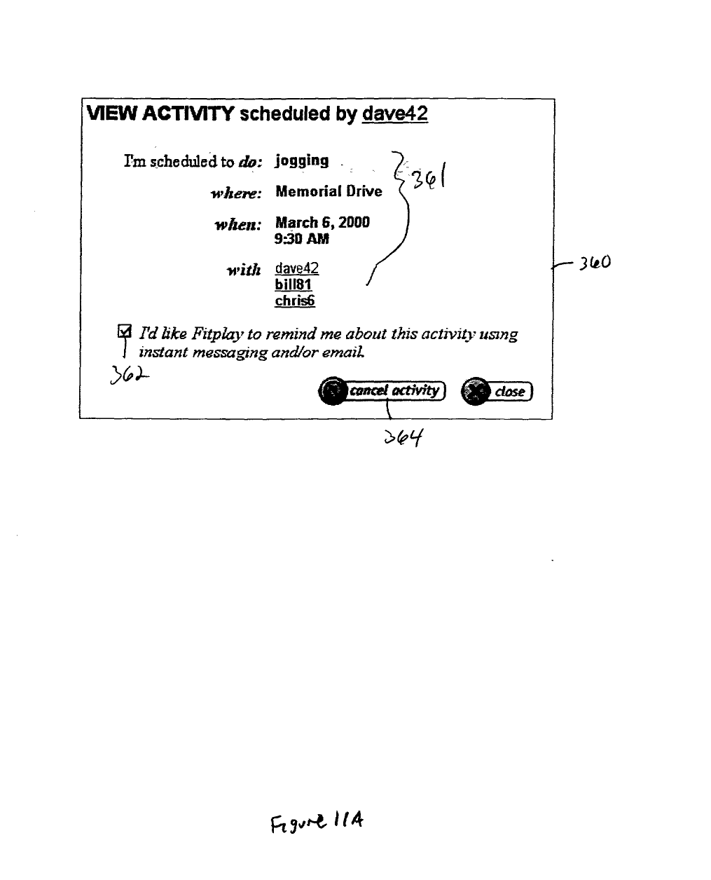

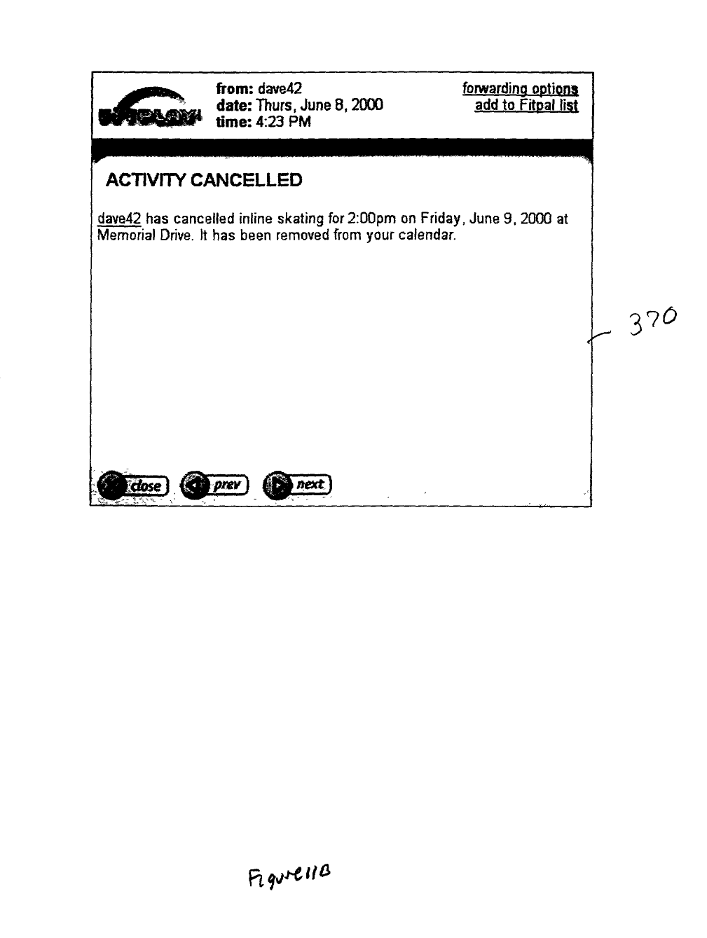

A party may view particulars regarding a scheduled activity via the service. FIG. 11A shows an example of a display 360 regarding an activity. The particulars 361 of the activity are listed as well as a check box 362 that enables the party to request a reminder. Button 364 enables the party to request a cancellation of the activity from the party's calendar. If a party cancels an activity, a cancellation communication, such as cancellation email 370 shown in FIG. 11B, is forwarded to other participants that are scheduled for the fitness activity.

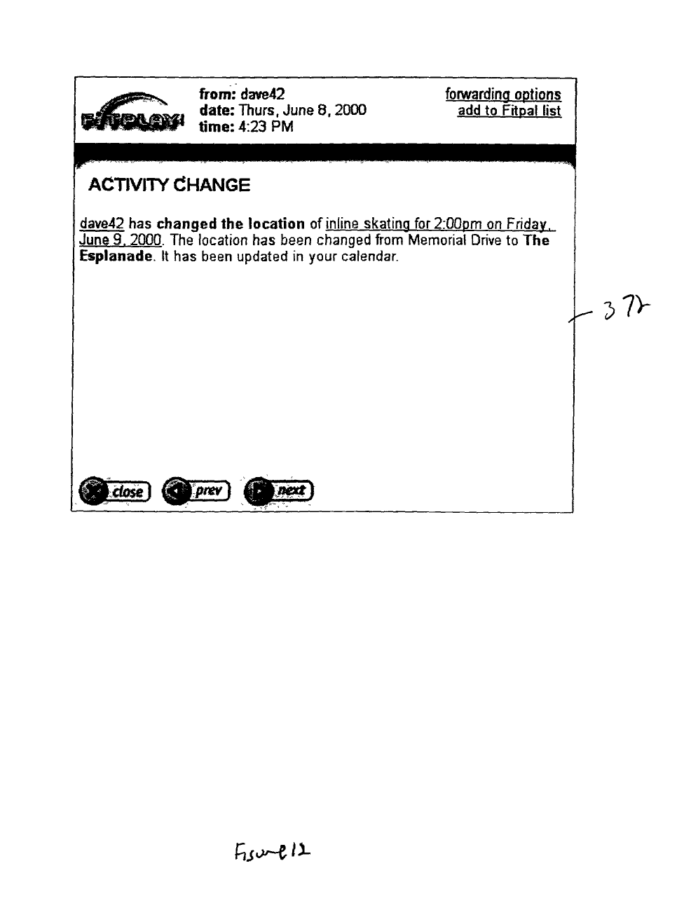

The party that initiated the scheduling of fitness activity may change the parameters regarding the activity. In such a case an activity change communication 372 (FIG. 12) is forwarded to other participants.

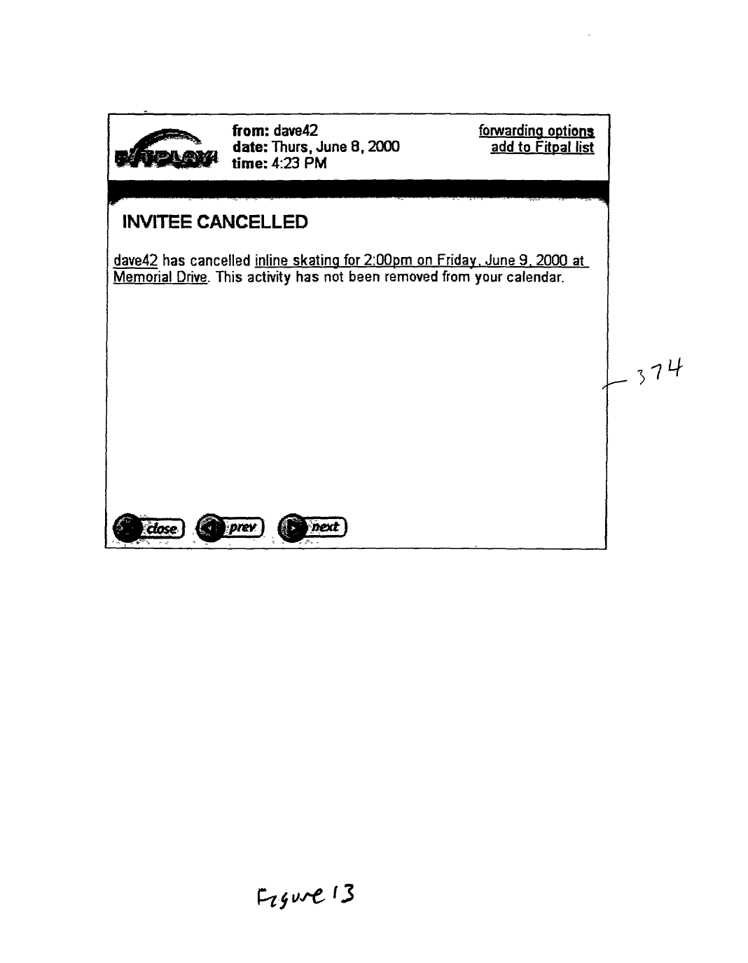

Invitees may cancel their participation in a fitness activity. In such a case, participants are informed by an invitee cancelled communication 374 (FIG. 13).

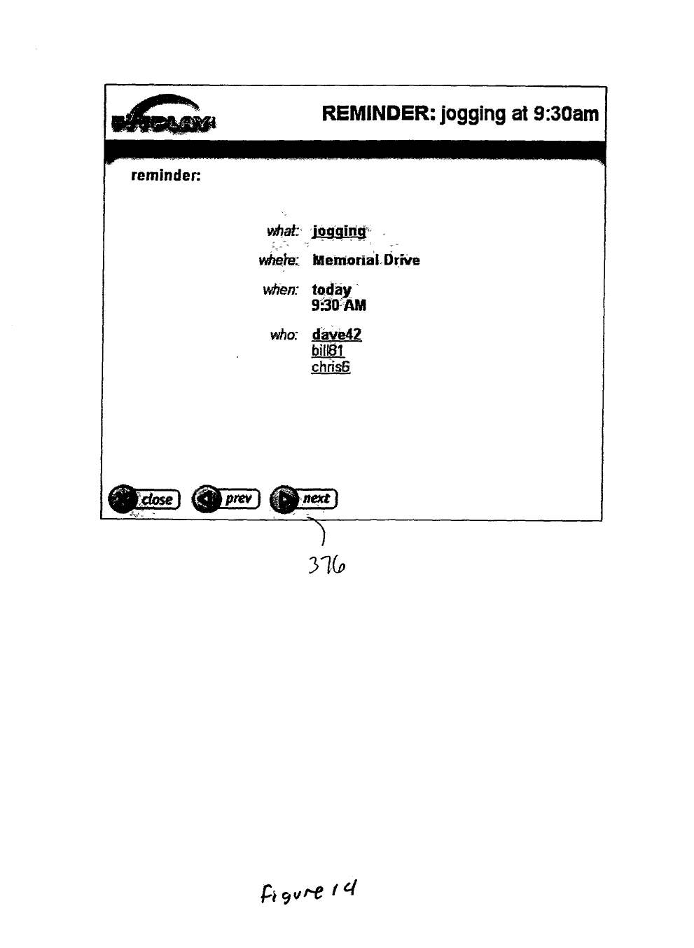

As mentioned above, the service provides reminders to help motivate members to participate in fitness activities. FIG. 14 shows an example of a reminder 376. The reminder specifies the particulars of the activity, such as type of activity, location, date and time, and scheduled participants.

Participants are able to provide feedback regarding fitness activities and participants that jointly participated in the fitness activity. The service provides a form 380 that enables users to specify this information. The participant is requested to provide information regarding the quality of the overall experience. Participant is asked to provide information regarding the quality of the overall experience for fellow participants in the fitness activity 384. The participant is asked to rate the location where the fitness activity took place 386. The participant may also provide additional comments 388. Participant may specify the time and duration of the fitness activity 390 and the skill level of the participant 392.

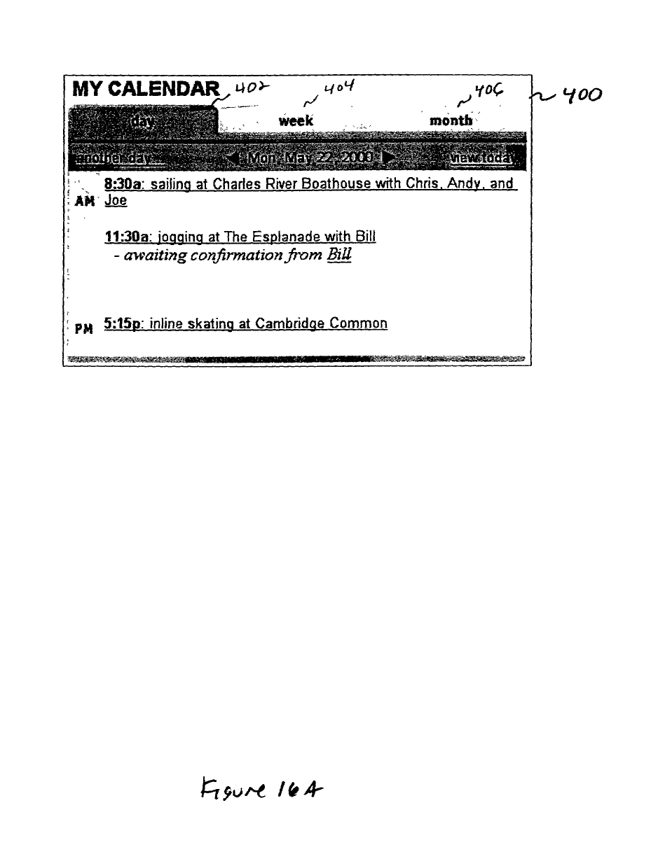

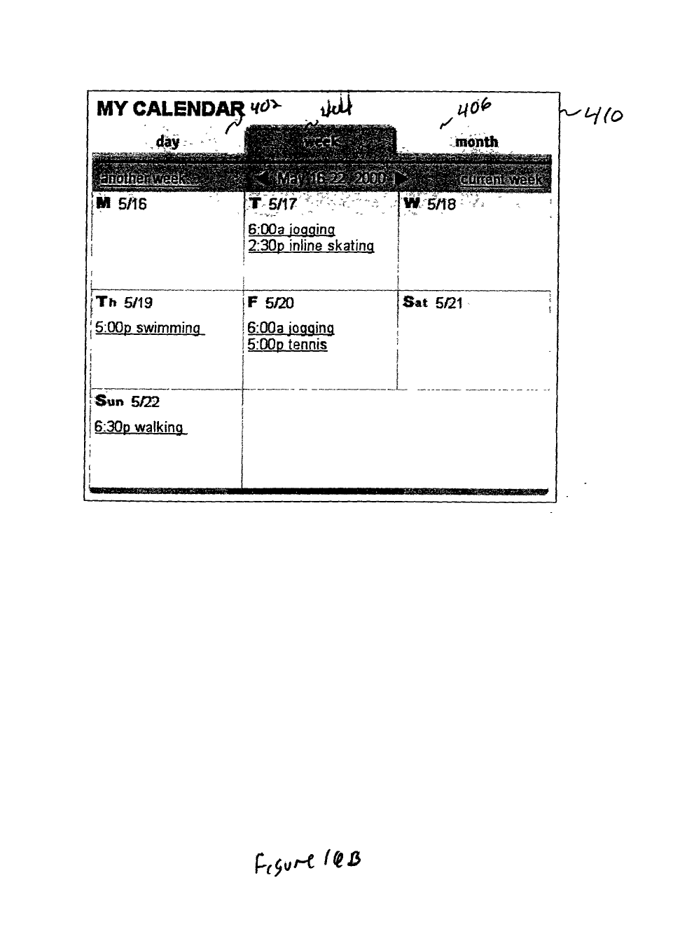

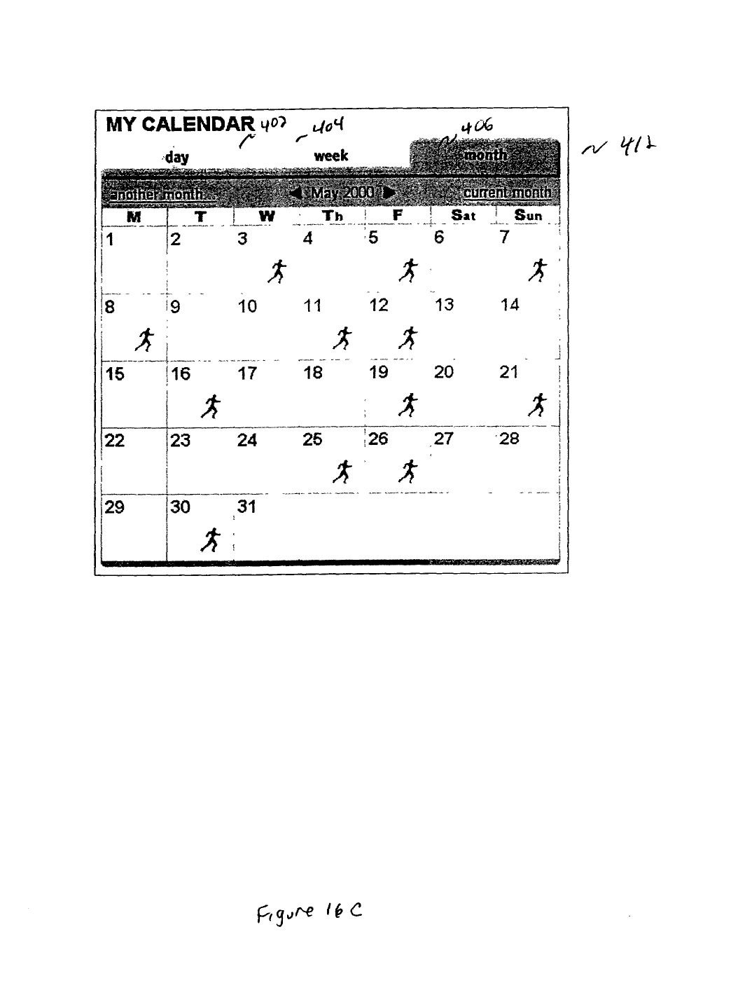

The service enables each member to maintain a calendar of fitness activities. As shown in FIG. 16A, the calendar for 100 may have tabs 402, 404, and 406 for selecting a day's view, week's view, or month's view of fitness activities. In the example shown in FIG. 16A, the day's view of the fitness activity is listed. The calendar 400 lists the activities that are scheduled for the party during the current day or selected day. FIG. 16B shows an example of a week's view where fitness activities for an entire week are displayed. Lastly, FIG. 16C shows a month's view, which lists fitness activities for an entire month.

The present invention has been described with reference to an illustrative embodiment thereof. Those skilled in the art will appreciate that various changes in form and detail may be made without departing from the intended scope of the present invention as defined in the appended claims. For example, these interface elements depicted in the drawings may differ significantly in alternative embodiments of the present invention. The user interface elements depicted in the drawings are intended to be merely illustrative and not limiting of the present invention.

1. In an electronic device, a method, comprising the steps of:
providing user profiles regarding users and fitness activities of the users; and
examining the user profiles to match at least two selected ones of the users for a scheduled fitness activity.

2. The method of claim 1, wherein the method further comprises the step of informing a first of the selected users of the scheduled fitness activity.

3. The method of claim 2, wherein the informing comprises sending an invitation to participate in the scheduled fitness activity to the first selected user.

4. The method of claim 3, wherein the invitation includes a user interface component for enabling the first selected user to accept or decline the invitation.

5. The method of claim 4, wherein the method further comprises sending a communication to the second selected user informing the second selected user whether the first selected user accepted or declined the invitation.

6. The method of claim 1, wherein calendars of fitness activities are maintained for the selected users and wherein the method further comprises the step of adding the scheduled fitness activity to the calendars of the selected users.

7. The method of claim 6, wherein the selected users have client devices with displays and wherein the client devices communicate with the electronic device and wherein the method further comprises the step of displaying the calendar for at least one of the calendars on the display of at least one of the client devices.

8. The method of claim 1, wherein the electronic device is a computer system.

9. The method of claim 1, wherein the step of examining is prompted by one of the selected users requesting the scheduling of the scheduled fitness activity.

10. The method of claim 9, wherein the method further comprises the step of providing a user interface element for specifying which of the users to invite to the scheduled fitness activity.

11. The method of claim 10, wherein the user interface element is part of a web page.

12. The method of claim 9, wherein the method further comprises the step of providing a user interface component for specifying a date, time and place for the scheduled fitness activity.

13. The method of claim 12, wherein the user interface component for specifying a date, time and place is part of a web page.

14. The method of claim 9, wherein the method further comprises the step of providing a user interface component for identifying what type of fitness activity the scheduled fitness activity is.

15. In an electronic device, a method, comprising the steps of:
providing a user interface that enables a user to request a suitable partner for a fitness activity;
conducting a search of candidate partners to locate a suitable partner; and
returning to the user a list of any suitable partners.

16. The method of claim 15, wherein the user interface enables the user to specify characteristics of a suitable partner.

17. The method of claim 16, wherein the search looks for candidate partners having the specified characteristics.

18. The method of claim 17, wherein only candidate partners matching at least some of the specified characteristics are set forth on the list.

19. The method of claim 16, wherein the user interface enables the user to specify suitable ages as one of the characteristics for a suitable partner.

20. The method of claim 16, wherein the user interface enables the user to specify a suitable geographic locale as one of the characteristics for a suitable partner.

21. The method of claim 16, wherein the user interface enables the user to specify a suitable skill level at the fitness activity for suitable partners.

22. The method of claim 16, wherein the method further comprises the steps of:
receiving at least one user choice from the list of suitable partners; and
sending an invitation communication to the user choices to participate in the fitness activity.

23. The method of claim 15, wherein the user interface is provided to the user via a network.

24. The method of claim 23, wherein the network is a computer network.

25. The method of claim 24, wherein the computer network is the Internet.

26. In a computer system, a method, comprising the steps of:
providing a web site having:
a matching facility for identifying persons that are well-matched to a first user for a particular type of fitness activity;
a scheduling facility for scheduling fitness activities among persons;
using the matching facility to identify at least one person that is well-matched to the user for a first type of fitness activity; and
using the scheduling facility to schedule a first event of the first type of fitness activity between participants, including the first user and the well-matched person.

27. The method of claim 26, further comprising the step of:
sending electronic reminders to the participants of the scheduled first event of the first type of fitness activity.

28. The method of claim 26, further comprising the steps of:
receiving a communication indicating that a selected one of the participants can no longer participate in the first event of the first type of fitness activity; and
adjusting the scheduling of the first event of the first type of fitness activity with the scheduling facility to indicate that the selected participant will not participate.

29. The method of claim 26, further comprising the steps of:
receiving a communication requesting cancellation of the first event of the first type of fitness activity;
in response to the communication, cancelling the first event of the first type of fitness activity with the scheduling mechanism.

30. The method of claim 29, further comprising the step of:
sending electronic notification to each of the participants of the first event of the first type of fitness activity that the first event of the first instance of the first type of fitness activity has been cancelled.

31. The method of claim 26, further comprising the steps of: p1 receiving a communication requesting a change in the first event of the first type of fitness activity;
in response to the communication, modifying scheduling of the first event of the first type of fitness activity; and
sending electronic notifications to the participants to inform the participants of the modifying of the scheduling of the first event of the first type of fitness activity.

32. The method of claim 31, further comprising the step of:
providing participants with an option of designating whether the participants wish to continue to participate in the first event of the first type of fitness activity in view of the modifying of the scheduling.

33. The method of claim 26, further comprising the step of:
using the scheduling facility to schedule a second event of the first type of fitness activity.

34. The method of claim 33, wherein the second event is scheduled for a second user.

35. The method of claim 26, further comprising the step of:
using the scheduling facility to schedule a third event of a second type of fitness activity.

36. In an electronic device, a method, comprising the steps of:
prompting a participant in a fitness activity for feedback regarding a selected participant in the fitness activity;
in response to the prompting, obtaining the feedback regarding the selected participant; and
making information regarding the feedback available to parties that are considering scheduling a fitness activity with the selected participant.

37. The method of claim 36, further comprising the step of:
making feedback from other participants of the fitness activity regarding the selected participant available to the parties.

38. The method of claim 36, further comprising the step of:
making additional feedback from other fitness activities regarding the selected participant available to the parties.

39. The method of claim 36, wherein the prompting is performed over a computer network.

40. The method of claim 36, wherein the information regarding the feedback is made available over a computer network.

41. A storage medium for use in an electronic device, said medium holding instructions for performing a method, comprising the steps of:
providing user profiles regarding users and fitness activities of the users; and
examining the user profiles to match at least two selected ones of the users for a scheduled fitness activity.

42. The storage medium of claim 41, wherein the method further comprises the step of informing a first of the selected users of the scheduled fitness activity.

43. The storage medium of claim 41, wherein the informing comprises sending an invitation to participate in the scheduled fitness activity to the first selected user.

44. The storage medium of claim 41, wherein the invitation includes a user interface component for enabling the first selected user to accept or decline the invitation.

45. The storage medium of claim 41, wherein the method further comprises sending a communication to the second selected user informing the second selected user whether the first selected user accepted or declined the invitation.

46. The storage medium of claim 41, wherein calendars of fitness activities are maintained for the selected users and wherein the method further comprises the step of adding the scheduled fitness activity to the calendars of the selected users.

47. A storage medium for use in an electronic device, said medium holding instructions for performing a method, comprising the steps of:
providing a user interface that enables a user to request a suitable partner for a fitness activity;
conducting a search of candidate partners to locate a suitable partner; and
returning to the user a list of any suitable partners.

48. The storage medium of claim 47, wherein the user interface enables the user to specify characteristics of a suitable partner.

49. The storage medium of claim 48, wherein the search looks for candidate partners having the specified characteristics.

50. The storage medium of claim 49, wherein only candidate partners matching at least some of the specified characteristics are set forth on the list.

51. The storage medium of claim 48, wherein the user interface enables the user to specify suitable ages as one of the characteristics for a suitable partner.

52. The storage medium of claim 48, wherein the user interface enables the user to specify a suitable geographic locale as one of the characteristics for a suitable partner.

53. The storage medium of claim 48, wherein the user interface enables the user to specify a suitable skill level at the fitness activity for suitable partners.

54. A storage medium for use in an electronic device, said storage medium holding instructions for performing a method, comprising the steps of:
prompting a participant in a fitness activity for feedback regarding a selected participant in the fitness activity;
in response to the prompting, obtaining the feedback regarding the selected participant; and
making information regarding the feedback available to parties that are considering scheduling a fitness activity with the selected participant.
